(19) United States
(12) Patent Application Publication
(10) Pub. No.: US 2024/0278271 A1
(43) Pub. Date: Aug. 22, 2024

(54) SYSTEMS, METHODS, AND APPARATUSES FOR A REUSABLE PUMP SPRAY AND BOTTLE ASSEMBLY AND REPLACEMENT CAPSULE FOR PERSONAL CARE PRODUCT DISPENSING SYSTEM

(71) Applicant: IM Pro Makeup NY LP

(72) Inventors: Oran Holtzman, New York, NY (US); Maayan Gianella, Tel Aviv (IL)

(73) Assignee: IM Pro Makeup ny lp, (omitted)

(21) Appl. No.: 18/171,622

(22) Filed: Feb. 20, 2023

(51) Int. Cl. B05B 11/10; A45D 34/04; A47K 5/12

(52) U.S. Cl. CPC B05B 11/1047; A45D 34/04; A47K 5/1201; B05B 11/1001; A45D 2200/055; A45D 2200/057

(57) ABSTRACT

A liquid product spray dispenser includes a liquid spray pump and cartridge containing personal care liquid product and is adapted for cartridge replacement to facilitate personalized product replenishment. The dispenser comprises a pump assembly and a housing for containing a replaceable cartridge containing a personal care liquid. To avoid mess, the cartridge includes a tube and pump engine adapter to facilitate replacement of spent cartridges. The cartridge may be releasably secured to the dispenser or pump assembly such that a user may remove the cartridge from the dispenser or pump and replace the cartridge with another cartridge containing the same or a different product.

### FIELD OF THE INVENTION

The present application relates to dispensing systems for dispensing fluid-based personal care products including hair care, skin care, body care, and cosmetic products and in particular to pump spray bottle type dispensing systems and more particularly to atmospheric or so-called “straw type” pump applications.

### BACKGROUND OF THE INVENTION

A wide range of personal care products, including hair care, skin care or skincare, body care, cosmetics, foundation, concealer, primer, and a range of other beauty products, that consumers replenish frequently. As used herein, personal care and beauty care are used interchangeably to cover the afore-mentioned broad range of products. Often personal care products are selected based on consumer experience with trying such products and achieving a certain result. For these products, rather than seeking newness and variety, consumers purchase the same product for consistency in application and results. Disposable personal product dispensing devices are wasteful and add to the expense of maintaining a supply of personal care products that are often used daily. Also, the significant packaging typically associated with personal care products adds to the expense of replenishing a consumer's product. High-end or “luxury” brands can have especially expensive packaging and e-commerce brands may be burdened with the extra expense of shipping costs based on volume and weight. This means the consumer ends up paying more to replenish personal care product supply.

Examples of prior solutions related to cartridge-based replenishment include the following: The present application is a continuation-in-part of and claims the benefit of priority to each of the following: U.S. patent application Ser. No. 17/454,850 (Atty Docket IM012US1), entitled SYSTEMS, METHODS, AND APPARATUSES FOR A REUSABLE DROPPER AND BOTTLE ASSEMBLY AND REPLACEMENT CAPSULE FOR PERSONAL CARE PRODUCT DISPENSING SYSTEM, filed 15 Nov. 2021, by Holtzman et al.; U.S. patent application Ser. No. 16/947,933, now issued as U.S. Pat. No. 11,117,149, (Atty Docket IM003US1), entitled SYSTEMS, METHODS, AND APPARATUSES FOR A CARTRIDGE DISPENSING SYSTEM AND RETENTION MECHANISM, filed 24 Aug. 2020, by Holtzman; U.S. Pat. App. Ser. No. 17/248,139, (Atty Docket IM003US2), entitled SYSTEMS, METHODS, AND APPARATUSES FOR A CARTRIDGE DISPENSING SYSTEM AND RETENTION MECHANISM, filed 11 Jan. 2021, by Holtzman; U.S. Provisional Pat. App. No. 62/890,565 (Atty Docket IM003PRV), entitled SYSTEMS, METHODS, AND APPARATUSES FOR A CARTRIDGE DISPENSING SYSTEM AND RETENTION MECHANISM, filed 22 Aug. 2019, by Holtzman, each of which is incorporated by reference herein in its entirety.

What is needed is a product and in particular a personal care product dispensing system that provides for less expensive replenishment while maintaining an elevated consumer experience that is both seamless and fun. Such a product would increase customer loyalty to the brand providing it by dramatically decreasing the cost to the consumer of replenishing product while maintaining the same or an improved customer experience.

Such a replenishment mechanism would also enable the brand to launch a subscription service. In beauty today, we see “trial” subscription services where the consumer receives recurring shipments of mystery boxes with different product assortments. However, we do not see any companies that are successful in selling either single-brand or fixed-product subscriptions.

Another challenge in the beauty industry today is sustainability. The large amount of packaging used for beauty products is of increasing concern within today's political climate and among younger consumers.

Another challenge is when the liquid product is of the type that includes alcohol, then airless-type spray or dispenser systems that are vented result in unwanted evaporation and loss and degradation of product. What is needed is a dispenser that avoids this defect.

Another challenge is liquid viscosity (referred to as absolute or dynamic viscosity), i.e., internal friction—the resistance or opposition of a fluid to a flow or relative movement, or fluidity, i.e., essentially the opposite of viscosity—the ease of flow of a fluid. Viscosity and fluidity are reciprocal so the greater the viscosity the lesser the fluidity and vice versa and both are temperature dependent. For example, water or “watery liquid” has a lower viscosity and is less viscous (greater fluidity) than molasses or a “syrupy” or gel liquid that is more viscous (thicker). For liquids, viscosity is inversely proportional to temperature and fluidity is directly proportional to temperature. Also, gas and liquid fluids behave in an inverse manner, i.e., the viscosity of a gas increases (becomes more resistant to flow) with an increase in temperature and the viscosity of a liquid decreases (liquid flows more easily) with an increase in temperature. Viscosity/fluidity are considered when determining how much force is needed to cause a fluid/liquid to move through a system. When designing a pump mechanism to move liquid from one location to another the viscosity of the liquid is a key consideration or factor. Further explanation of viscosity may be found at https://en.wikipedia.org/wiki/Viscosity. Also, the viscosity of the liquid is critical to the application, e.g., when designing a “spray” dispenser with spray nozzle for forcefully ejecting a liquid product the lower the viscosity the easier it is to push the liquid out the nozzle and dispense it in a desired pattern. Nozzles control the flow rate, speed, direction and pressure of the liquid. For example, a simple hand pump for dispensing a soap gel would not have the same outlet or nozzle design as a pump intended to disperse a less viscous liquid, such as for a hair spray application. What is needed is a dispenser capable of effectively dispersion personal care liquid products that have a viscosity closer to that of water than that of a gel product.

What is needed is a product that can deliver an equally elevated consumer experience while requiring less packaging and being more environmentally friendly. Many consumers demand the products they purchase are “eco-friendly.”

What is needed is an improved atmospheric-type pump for effectively dispersing liquid personal care product having a viscosity consistent with atmospheric straw-type dispensing mechanisms.

What is needed is an improved dispenser capable of being refilled and reused by consumers.

### SUMMARY OF THE INVENTION

The present invention is a product that supports ongoing replenishment by providing a reusable dispenser and a system of replacement cartridges for replenishment of personal care liquid product. The improved replenishment system provides an atmospheric-type pump mechanism with “straw”-based dispensing tube incorporated directly into the replacement cartridge to avoid spillage and mess during replacement. The dispenser is ventless in the sense that contents of the cartridge reservoir are not directly subjected to evaporation, e.g., the ventless system avoids the problem of vented airless systems wherein contents contain alcohol and may suffer from loss of product and degradation of quality over time. The viscosity of the personal care liquid product is relatively low and close to that of water and is consistent with an atmospheric, non-pressurized cartridge or capsule and delivery system.

The improved system provides a more cost-effective approach for providers and customers. In this manner the system makes it less expensive for a company to replenish the consumer's product and, therefore, it makes it less expensive for the consumer to continue buying the same or other compatible products for replacement. This approach has the added benefit of increasing consumer loyalty. The replenishment mechanism also has a lower environmental impact, resonating with consumer values. The replenishment experience is seamless and fun for the consumer. Finally, the reusable dispenser may be used to support a variety of personal care products supplied in a common replacement capsule or cartridge format. This means that consumers can exchange capsules supported by the reusable dispenser as they desire to enjoy use of the base dispensing mechanism with multiple product types. We use the term capsule and cartridge interchangeably.

When the consumer uses up or depletes personal care product, the consumer can easily replace them. For example, the consumer may open the dispenser at the top cover, which may be completely removable in a threaded manner. The consumer then removes the spent capsule of product and replaces it with a new capsule of the same or other type of product. The consumer then replaces the cover on the dispenser and proceeds to use the dispenser as before. The process of replacing the capsule provides an improved configuration that is mess-free and spill-proof. The capsules in this manner provided added benefit as they are comprised of significantly thinner material than the reusable dispenser and are therefore significantly less expensive to make and less expensive to ship. They also have a reduced environmental impact. To make it easy for the consumer to refill the product correctly—specifically to make sure they are replacing a used capsule with the same type of product—the capsules may be color-coded or themed or designed with different patterns that are easily recognizable.

The present invention may be applied to a wide range of personal care products. The dispenser and replaceable capsule system can be applied to any liquid product consistent with the atmospheric dispenser.

The present invention also provides for a personal care product subscription service that is the first of its kind. This subscription could be for any type of frequently replenished liquid or skincare or hair care or other personal care product. For example, for a subscription leveraging the reusable dispenser and capsule system of the present invention, the consumer would initially receive the reusable dispenser and a set of capsules, each with a different type of product. The consumer would then subscribe to receive regular deliveries of capsules, which they would use to refill the reusable dispenser. The cadence of the deliveries could be customized to the consumer's usage speed for both types of products. Due to the reusable configuration of the dispenser, the more limited packaging of the capsules, the shipping costs would be relatively low compared to shipping a traditional product case. The reduced shipping costs plus the reduced packaging costs would enable this service and product to be provided to consumers at a lower cost relative to a subscription service using traditional product packaging. The consumer experience would remain elevated due to the ease and fun of replacing the product capsules. Also, while prior dispenser systems might allow for manual refilling of a dispenser, this is often messy and detracts from user experience. Also, many personal care products are not available in larger “refill” formats and are not possible.

In a first embodiment, the present invention provides a liquid dispenser adapted to removably receive a replaceable capsule and dispense a liquid personal care product contained in an installed capsule, the dispenser comprising: a housing having a top and a bottom and defining an interior space, the top having an opening; and a liquid spray pump assembly comprising a pump engine having an inlet and an outlet, the pump engine having a tube interface component; a cartridge adapted to be received within the interior space of the housing through the top opening, the cartridge defining a reservoir for containing liquid product, the cartridge comprising: a pump engine adapter configured to receive the pump engine tube interface component with the cartridge joined with the liquid spray pump assembly; and a tube disposed within the reservoir, the tube having a first end supported by the pump engine adapter and defining an outlet, and a second end defining an inlet in communication with liquid product contained in the reservoir; the liquid spray pump assembly being configured to alternately attach to and detach from the housing to allow, alternately, for insertion and removal of the cartridge to facilitate replacement of a spent cartridge with a fresh replacement cartridge; whereby with the cartridge joined with the liquid spray pump assembly, the pump engine adapter receives the pump engine tube interface and provides a continuous path for liquid from the reservoir to pass into and through the spray tube and into the liquid spray pump assembly and, upon actuation of the pump engine, liquid product contained in the reservoir is drawn into the tube via the tube inlet, flows through the tube and through the pump engine tube interface, and exits the pump engine outlet for dispensing of the liquid product for use by a user.

The liquid dispenser of the first embodiment may be further characterized in any one or more of the following manners: wherein the pump engine is spring-biased and is actuated upon a user depressing a spray head provided on the liquid spray pump assembly to cause the pump engine to draw a pre-determined amount of liquid from the reservoir; wherein the housing further comprises a support component adapted to removably attach to the top of the housing, the support component having a pump engine support portion adapted to join with and support the liquid spray pump assembly; wherein the housing includes a threaded circumference at the housing top, and the support component includes a first set of threads adapted to mate with and removably secure the support component with the threaded circumference; wherein the support component includes a cartridge support portion adapted to mate with and support the cartridge; wherein the cartridge includes a threaded neck, and the support component includes a second set of threads adapted to mate with and removably secure the support component with the cartridge threaded neck; further comprising a cap adapted to be removably attached to the housing and adapted to cover and protect an exposed portion of the liquid spray pump assembly, including the outlet, and adapted to prevent undesired actuation of the pump engine; wherein one or both of the pump engine tube interface and the pump engine include a sifter adapted to clear or wipe liquid when the cartridge is removed from the body to prevent spillage and mess; further comprising a bottom cover for attaching to and protecting the bottom of the housing, the bottom cover having a flat portion to promote stability of the dispenser when placed on a flat surface; wherein at least a portion of the housing is transparent or semi-transparent to reveal at least in part the interior space, including a portion of the cartridge; wherein the capsule includes indicia disposed on the outside of the cartridge concerning the personal care product contained in the cartridge, whereby with the cartridge contained in the housing, the indicia is visible through the transparent or semi-transparent portion of the housing to ensure user awareness of personal care liquid dispensed.

In a second embodiment the present invention provides a cartridge containing personal care liquid and adapted for use with a dispenser for dispensing personal care liquid, the dispenser having a pump engine and a housing adapted to removably receive a cartridge, the cartridge comprising: a body having a top and a bottom and generally defining a reservoir and configured to be received within a correspondingly configured dispenser housing, the top defining an opening; a pump engine adapter adapted to be received at least in part through the opening and into the reservoir and to be securely affixed to the top of the body, the pump engine being configured to receive a portion of a dispenser pump engine with the cartridge disposed in a dispenser; and a tube disposed within the reservoir, the tube having a first end supported by the pump engine adapter and having an outlet, and a second end having an inlet in communication with the liquid product contained in the reservoir; wherein the tube and the pump engine adapter provide a continuous path through which liquid from the reservoir passes into and through the tube and into the pump engine adapter.

The cartridge of the second embodiment may be further characterized in any one or more of the following manners: wherein the pump engine adapted includes a sifter to prevent liquid from flowing into the pump engine adapter from the reservoir; wherein with a pump engine disposed into the pump engine adapter, the sifter is displaced to permit flow of liquid from the reservoir into the pump engine; wherein upon actuation of the pump engine, liquid product contained in the reservoir is drawn into the tube via the tube inlet, flows through the tube and through the pump engine adapter and into the pump engine, and exits a pump engine outlet for dispensing the liquid product; wherein the cartridge body further comprises: a connector portion disposed at the top and adapted to matingly secure the cartridge to the dispenser housing with the cartridge received within the dispenser housing; a cover removably affixed to the body and disposed over the opening and adapted to prevent spillage of the personal care product contained in the reservoir prior to installation of the cartridge in a dispenser housing; wherein the cartridge includes a threaded neck and the dispenser housing includes a retaining cover oppositely threaded to receive the threaded neck, whereby the cartridge is adapted to be secured to the dispenser housing by threading and screwing the threaded neck to the retaining cover; further comprising a sifter disposed at or near the cartridge opening for clearing liquid upon disjoining the cartridge from the pump engine to prevent spillage and mess; wherein the liquid product contained in the cartridge is essentially maintained at atmospheric pressure. The first embodiment liquid dispenser may be further characterized in one or more of the following manners and features: wherein the actuator mechanism is spring-biased and is self-actuated upon a user rotating the top component to draw in a pre-determined amount of liquid contained in the interior space of the body; wherein the actuator mechanism comprises a depressible pump adapted to causes personal care product liquid to flow into the dropper tube and to exit the dropper tube upon further action; further comprising a retaining cover adapted to be received on to the top of the body, the retaining cover comprising a threaded interior circumference serving as a first connector and adapted to matingly couple with an oppositely positioned threaded neck or shoulder serving as a second connector disposed on the top, whereby the retaining cover may be removably attached and secured to the top by threading and screwing the first and second connectors together; wherein the retaining cover further comprises a first neck extending upward from the top of the cover and defining an opening configured to receive therethrough the dropper tube, the first neck having a first neck threaded portion, and wherein the dropper top component includes a threaded interior portion, whereby the first neck threaded portion and the dropper top interior threaded portion are adapted to be threaded and screwed together to secure the dropper to the body with the dropper tube contained at least in part in the interior space of the body; wherein the retaining cover further comprises a second neck extending downward opposite the first neck and having a second neck threaded portion adapted to threadedly engage with a threaded portion of a capsule, whereby the second neck threaded portion and the capsule threaded portion are adapted to be threaded and screwed together to secure the capsule to the retaining cover and whereby the dropper tube is inserted through the first neck, through the second neck and into an interior space of the capsule; wherein the capsule is disposed within the interior space of the body through the top opening and the assembled dropper assembly and retaining cover are secured to the dispenser bottle body via the first and second connectors; wherein the capsule comprises an outer cap to conceal and protect the top of the capsule and to prevent spillage of liquid contents of the capsule prior to use, the outer cap being removeable from the capsule to provide access to the capsule threaded portion for secure attachment to the retaining cover; further comprising a sifter disposed at or near the opening for clearing liquid from the outside of the dropper tube when the dropper assembly is removed from the bottle body to prevent spillage and mess; further comprising a bottom cover for attaching to and protecting the bottom of the bottle body, the bottom cover having a flat portion to promote stability of the dispenser when place on a flat surface; wherein the capsule includes indicia disposed on the outside of the capsule indicating the personal care product contained in the capsule and with the capsule contained in the bottle body allowing the user to view the indicia through the transparent or semi-transparent portion of the body to ensure user awareness of personal care liquid dispensed.

### BRIEF DESCRIPTION OF THE DRAWINGS

To facilitate a full understanding of the present invention, reference is now made to the accompanying drawings, in which like elements are referenced with like numerals. These drawings should not be construed as limiting the present invention but are intended to be exemplary and for reference.

FIGS. 1A and 1B respectively provide cross-section and front views of an exemplary reusable liquid dispenser, which includes personal care liquid products for dispensing contained in a replaceable cartridge in accordance with a first embodiment of the present invention.

FIGS. 2A-2C provide a series of series of cross-section and front views illustrating components of the liquid dispenser of FIG. 1A according to an embodiment of the present invention; FIG. 2A provides a cross-section view of a liquid pump engine assembly, FIG. 2B provides a front view of a sub-section of the pump engine tube interface component, and FIG. 2C provides a cross-section of the dispenser housing.

FIGS. 3A-3B respectively provide cross-section and front views of an exemplary replacement cartridge containing personal care liquid products and for use with the reusable liquid dispenser of FIG. 1A in accordance with a first embodiment of the present invention.

FIGS. 4A-4B respectively provide cross-section and front views of an exemplary replacement cartridge body for containing personal care liquid products for use with the replacement cartridge of FIG. 3A in accordance with a first embodiment of the present invention.

FIG. 4C provides a top-down view of the exemplary replacement cartridge body for containing personal care liquid products for use with the replacement cartridge of FIG. 3A in accordance with a first embodiment of the present invention.

FIG. 5A provides a cross-section view of a first exemplary pump engine adapter and tube assembly for use with the replacement cartridge of FIG. 3A in accordance with a first embodiment of the present invention.

FIG. 5B provides a cross-section view of the first exemplary pump engine adapter for use with the replacement cartridge of FIG. 3A in accordance with a first embodiment of the present invention.

FIG. 6 provides a cross-section view of an exemplary cover or cap for use with the replacement cartridge of FIG. 3A in accordance with a first embodiment of the present invention.

FIG. 7 provides a combination of a front view of a partial pump engine and tube interface assembly of the dispenser of FIG. 2A for joining with the pump engine adapter of FIGS. 5A/5B according to an embodiment of the present invention.

FIG. 8A provides a front view of a second exemplary pump engine adapter and tube assembly for use with the replacement cartridge of FIG. 3A in accordance with a second embodiment of the present invention.

FIG. 8B provides a cross-section view of the second exemplary pump engine adapter and tube assembly for use with the replacement cartridge of FIG. 3A in accordance with a second embodiment of the present invention.

FIG. 9A provides a perspective view of the second exemplary pump engine adapter for use with the replacement cartridge of FIG. 11 in accordance with a second embodiment of the present invention.

FIG. 9B provides a front view of the second exemplary pump engine adapter for use with the replacement cartridge of FIG. 11 in accordance with a second embodiment of the present invention.

FIG. 9C provides a cross-section view of the second exemplary pump engine adapter for use with the replacement cartridge of FIG. 11 in accordance with a second embodiment of the present invention.

FIG. 9D provides a cross-section close-up view of an intermediate portion of the second exemplary pump engine adapter for use with the replacement cartridge of FIG. 11 in accordance with a second embodiment of the present invention.

FIG. 10 provides a combination of a front view of a partial pump engine and tube interface assembly of the dispenser of FIG. 2A for joining with the second embodiment pump engine adapter of FIGS. 8A-9D according to a second embodiment of the present invention.

FIG. 11 provides a cross-section view of a second exemplary replacement cartridge containing personal care liquid products and for use with the reusable liquid dispenser of FIG. 2A-2C in accordance with a second embodiment of the present invention.

### DETAILED DESCRIPTION OF THE INVENTION

The present invention will now be described in more detail with reference to exemplary embodiments as shown in the accompanying drawings. While the present invention is described herein with reference to the exemplary embodiments, it will be understood that the present invention is not limited to such exemplary embodiments. Those possessing ordinary skill in the art and having access to the teachings herein will recognize additional implementations, modifications, and embodiments, as well as other applications for use of the invention, which are fully contemplated herein as within the scope of the present invention as disclosed and claimed herein, and with respect to which the present invention could be of significant utility.

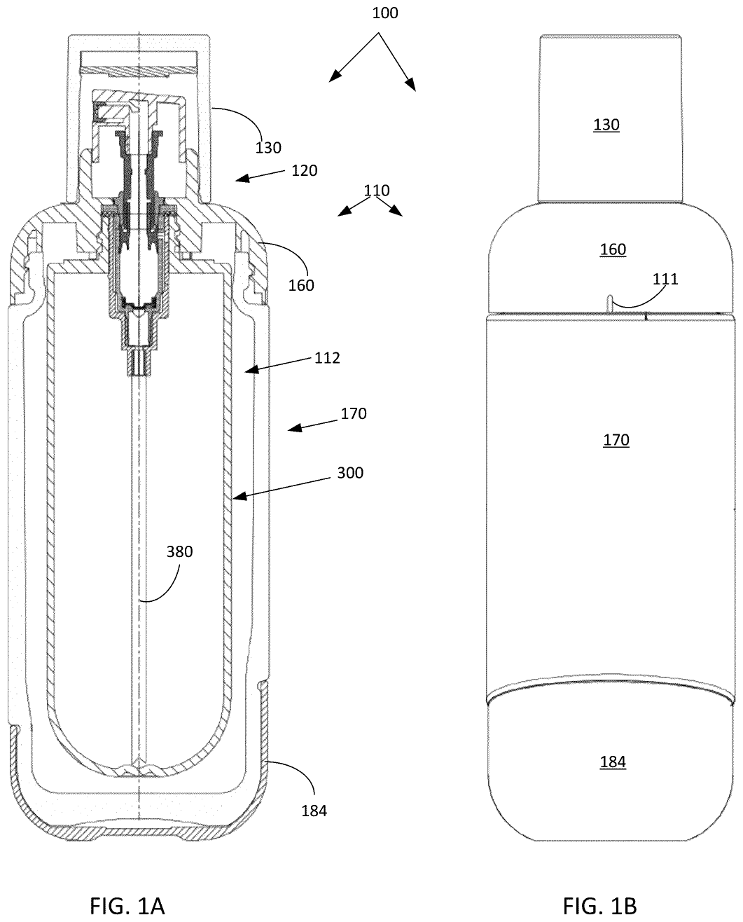

FIGS. 1A and 1B respectively provide cross-section and front views of an exemplary reusable liquid dispenser, which includes personal care liquid products for dispensing contained in a replaceable cartridge in accordance with a first embodiment of the present invention. FIGS. 1A and 1B illustrate a system 100 for dispensing and replenishing liquid personal care products, such as beauty care, skin care, hair care, cosmetics, or other personal products. With reference to FIGS. 1A and 1B, a fully assembled exemplary reusable liquid dispenser 100 includes a self-contained replacement capsule or cartridge (used interchangeably) 300 as shown represent a first embodiment of the present invention. Much like Keurig® K-cup coffee pods, the replacement capsule 300 is only usable when placed in the reusable dispenser bottle 110, which includes a liquid spray pump assembly 120, cap or cover 130, support component 160, dispenser body 170 and bottom protective cover 184. For eco-friendly enjoyment, the capsule assembly 300 is made preferably of plastic-PCR post-consumer recycled materials and may itself be recycled after use or returned/refilled.

Reusable liquid dispenser 110 includes a body or housing 170 having a top and bottom and that generally defines an interior space 112. The interior space 112 is configured to receive the capsule or cartridge 300, which contains personal care liquid products for dispensing via liquid spray pump assembly 120 as communicated via cartridge straw or tube 380. The body or housing 170 may include a transparent or semi-transparent or translucent portion to allow a user to visually inspect the capsule 300 when installed within interior space 112. As shown here, capsule 300 is disposed within interior space 112, although the dispenser 110 may initially be provided to the user unfilled, i.e., without a capsule, and ready for receiving a capsule, or may include a capsule installed, or may be provided with a capsule for insertion by the user. As shown the pump assembly 120, also referred to as a pump engine or pump engine assembly, is secured to a top portion or cover or collar or support component 160 of the body or housing 170 and may be removed from the housing, e.g., unscrewed if threaded. The support component 160 also includes means for securing a capsule to the support component. The support component may be detached to allow a user to remove a capsule, such as a spent capsule or a different capsule containing a different liquid product, and to install or secure a capsule to the support component 160. With the capsule secured to the support component, the dispenser assembly may be reassembled for use in dispensing liquid product contained in the capsule via the liquid spray pump assembly 120. The dispenser assembly includes a protective outer cap 130 to protect the pump assembly and to prevent inadvertent actuation of the pump assembly to avoid mess and waste of product.

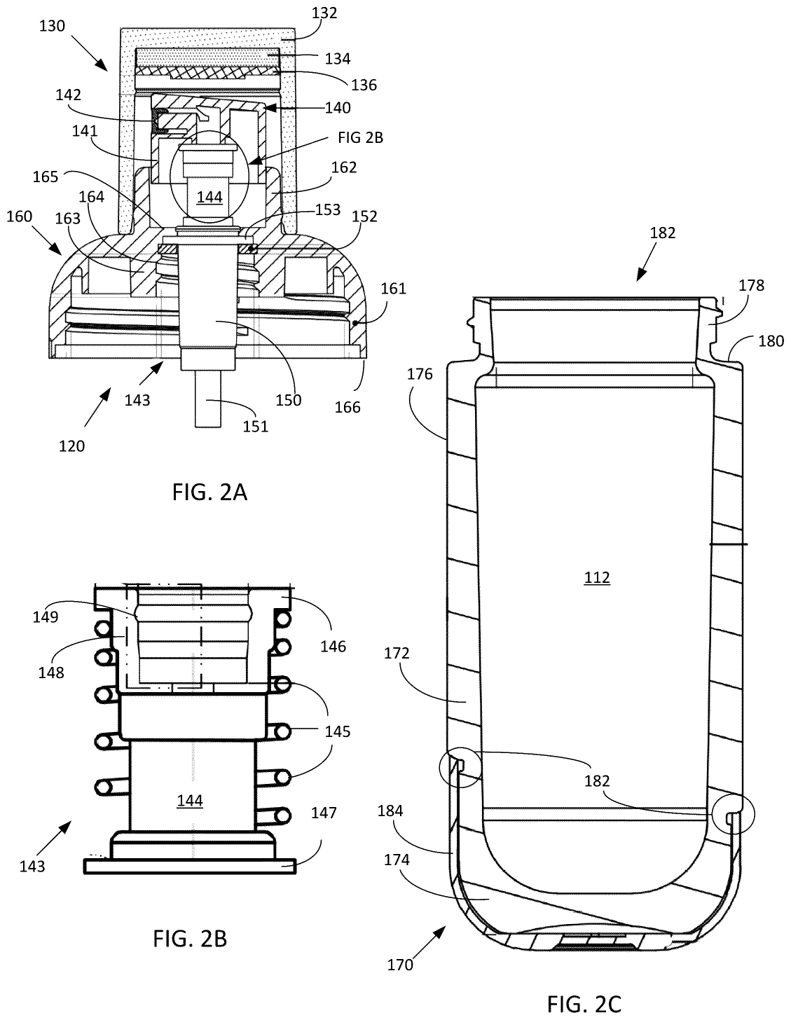

FIGS. 2A-2C provide a series of series of cross-section and front views illustrating components of the liquid dispenser of FIG. 1A according to an embodiment of the present invention.

FIG. 2A provides a cross-section view of a liquid pump engine assembly 120 and cap assembly 130 as supported on and by the support component 160. Support component 160 includes an outer shoulder portion 161, an upper neck or collar portion 162, an interior neck portion 163 having a set of threads 164, and a pump support rest 165. The outer shoulder portion 161 may include threads configured to be matingly received by threads formed on the upper neck 178 of the housing or body 170. Cap assembly 130 includes an over cap 132, a cap weight or disc 134 and an inner cap insert 136.

As shown the spray pump assembly 120 includes pump spray head 140 having a pump head 141, a pump spray outlet or nozzle 142, a straw or tube interface 143, a pump channel 144, a capsule insertion portion or component 150 and a tube connector 151. An interior annular seal or washer 152 is also provided, which may be rubber or plastic or other material designed to provide a flexible or compressible seat or cushion when abutted by the upper neck portion of a capsule when connected to the support component 160. The inner neck 163 is adapted or configured to receive and secure a neck portion 314 of a capsule 300, such as by mating threads during securement of the capsule to the support 160. The pump spray head 141 is adapted or configured to be slidingly (up and down motion of the pump head) received within a cavity or journal formed by the upper neck 162 to allow for actuation of the pump engine 120 during use. As discussed below, the pump engine is, in this example, spring-biased by spring 145, and includes a valve mechanism, e.g., a ball valve with valve seat, to preferably provide one-directional flow of the liquid product. With the dispenser in a resting condition the pump head is biased up and away from the rest 165 and then in use a force is applied to the pump head sufficient to overcome the opposite biasing force of the spring to cause the pump head to travel down and cause the liquid contained in the capsule 300 to be drawn into the tube 380 from reservoir 330, through the tube interface, through the pump engine and out the spray nozzle or outlet 142. The dispenser assembly is configured to prevent unwanted evaporation of liquid contents stored in the cartridge reservoir, such as alcohol products, and the pump engine and spray head are designed to operate in applications with liquid products having viscosities similar to that of water at a normal room temperature and/or within a range of viscosities close to that of water at room temperature.

FIG. 2B provides a front view of a sub-section of the pump engine tube interface component 143, which is shown to include a pump channel 144, a pump head support portion 148 having a pump head abutment and which is adapted and configured to provide a stop or rest or collar 146 to assist, along with opposite facing rest or collar or abutment 147, in retaining the spring 145 disposed and coiled along the length of the tube interface component.

FIG. 2C provides a cross-section of the dispenser housing assembly 170 and is shown having a main body portion 172, a lower body portion or bottom 174, and an upper body portion or top 176. The upper portion of top 176 includes an upwardly extending neck 178 configured to connect with the support component 160, e.g., by way of mating threads, complimentary insets or grooves and protuberances, or other suitable means. The support 160 is configured to join with the housing 170 so that lower abutment 166 of the support abuts with rest 180 adjacent to the neck 178. The housing assembly 170 may include a cover or sheath 184 configured to be placed over a portion of the lower body portion 174 to help protect the housing and dispenser. For example, the housing 172/174/176 may be made of glass and the cover 184 may be made of plastic or other protective material to avoid unwanted breakage of the housing. A complimentary set of protuberances and insets shown generally at 182 may be formed or provided in the cover and/or housing to permit “snap-on” or other secure placement of the cover on the housing. The cover may be substantially flat on a bottom surface to promote stability and upright posture of the housing and dispenser when placed on a flat surface.

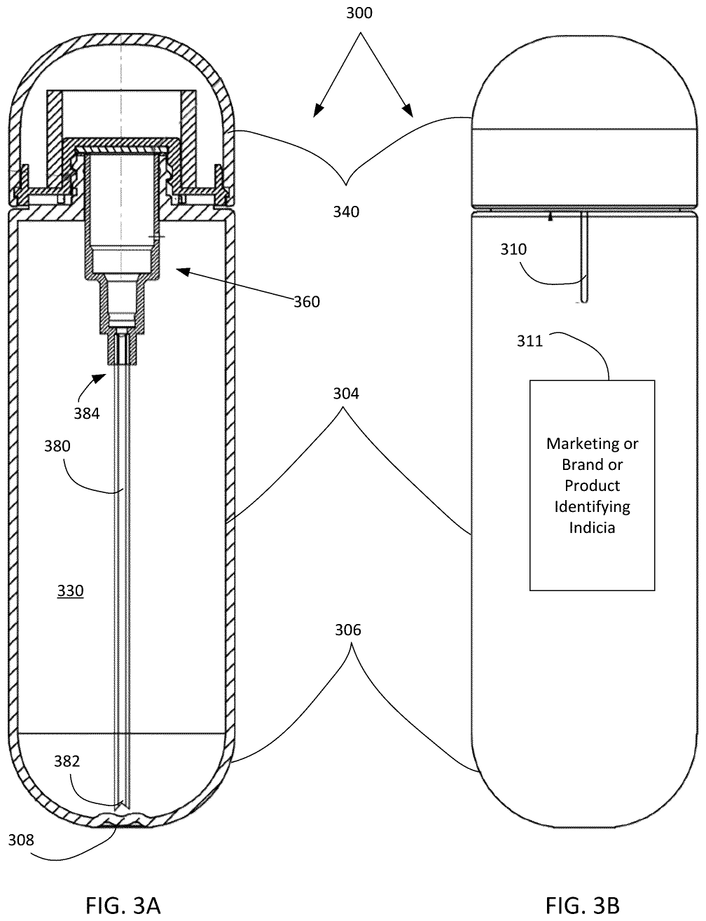

FIGS. 3A-3B respectively provide cross-section and front views of an exemplary cartridge 300, including a replacement cartridge, containing personal care liquid products and for use with the reusable liquid dispenser 110 of FIG. 1A in accordance with a first embodiment of the present invention.

FIG. 3A illustrates and exemplary self-contained refillable or replacement capsule 300 including a capsule top or cover 340 and a capsule body 304 that defines an interior liquid reservoir or cavity or space 330 in which liquid personal care product is stored. Cover 340 may be removeable by threaded attachment to the body 304 or may be a pop-off type and may be discarded upon detachment or opening of the capsule 300. When screwing a threaded cover 340 onto the threaded neck 314, a protrusion and recess pair may be provided, or similar means, to provide a “click” when the cover is fully and securely attached to the capsule 300. Preferably an airtight seal is formed when the cover 340 is connected to the capsule. In addition, a wrap or other seal or foil 312 may be placed over and about the circumference of the neck opening where the cover 340 meets the capsule body 300.

Cartridge 300 includes a pump engine adaptor 360 and a straw or tube or conduit or passage (referred to broadly herein as “tube”) 380. The tube 380 includes a bottom or lower end 382 having an opening or inlet for receiving liquid product stored in the reservoir 330 upon actuation of the pump engine when the cartridge is installed and the dispenser is fully assembled. As shown discontinuities may be provided at the opening and/or the bottom of the body 304 to prevent the tube from being butted up tight against the bottom and becoming blocked. An upper portion of the tube 380 includes an opening or outlet for allowing liquid to flow from the tube and into the pump engine adapted and pump engine when installed and in use. As shown in FIG. 3B, a line or marking or indicia 310 may be provided to line up or match with indicia or line or marking 111 shown in FIG. 1B to provide visual confirmation and feedback of proper alignment and placement of the capsule when installed on the support 160.

With the cover 340 removed, the capsule 300 may be attached to the support 160 and disposed or placed within housing or body 170 of re-usable dispenser 110 as described in detail herein. Capsule 300 may be refillable or disposable and may be returned to the retail or e-commerce source for a credit or other incentive to avoid waste associated with the container 300. Branding/text indicia 311 may be included on the body 304 and may be an adhesive label or otherwise affixed to the capsule body 304 and may include brand identifier, content description, application information, or other messaging visible when the capsule is placed into housing 170 via transparent portion made of glass or other transparent material. In this manner, the capsule 300 serves to inform the user as to the nature of the personal care product available for dispensing by the dispenser 100 to avoid misapplication of product. In this manner the user knows exactly what she/he is about to use to prevent inadvertent application of product. When capsule 300 is installed in dispenser 100, there is preferably an annular gap separating the body 170 of the housing from the body 304 of the capsule. The dispenser housing 170 is preferably glass and transparent to provide clear view of the capsule and any marking, e.g., brand logo or identifier, directions, product description, on the circumference of the body 304 of the capsule when assembled.

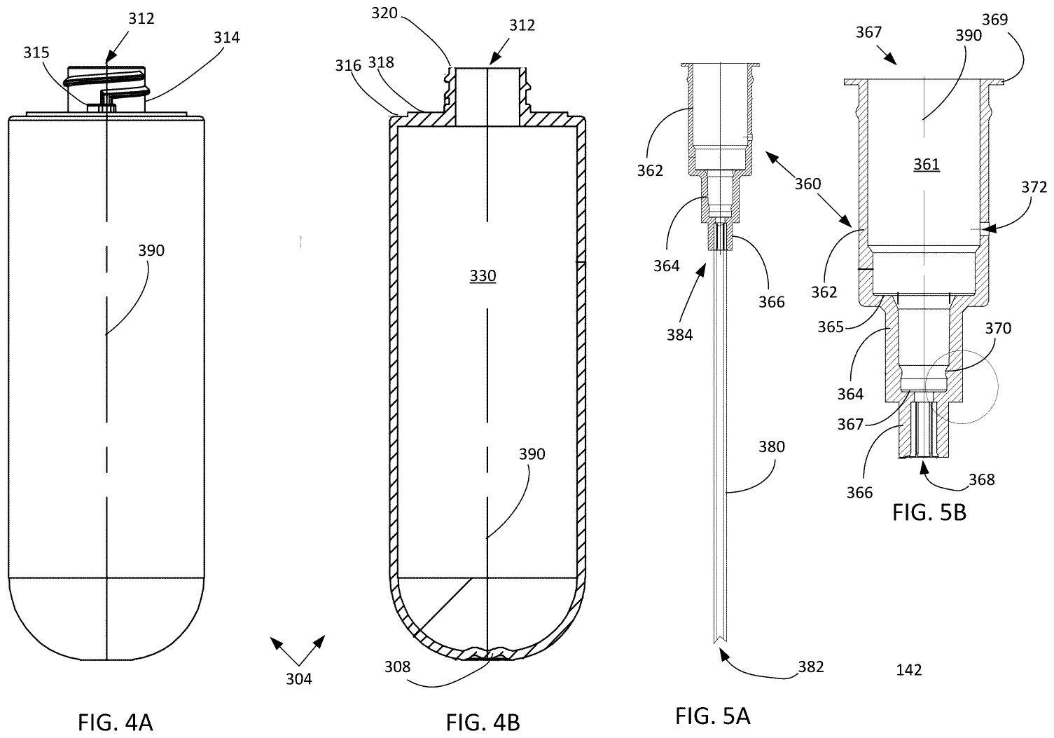

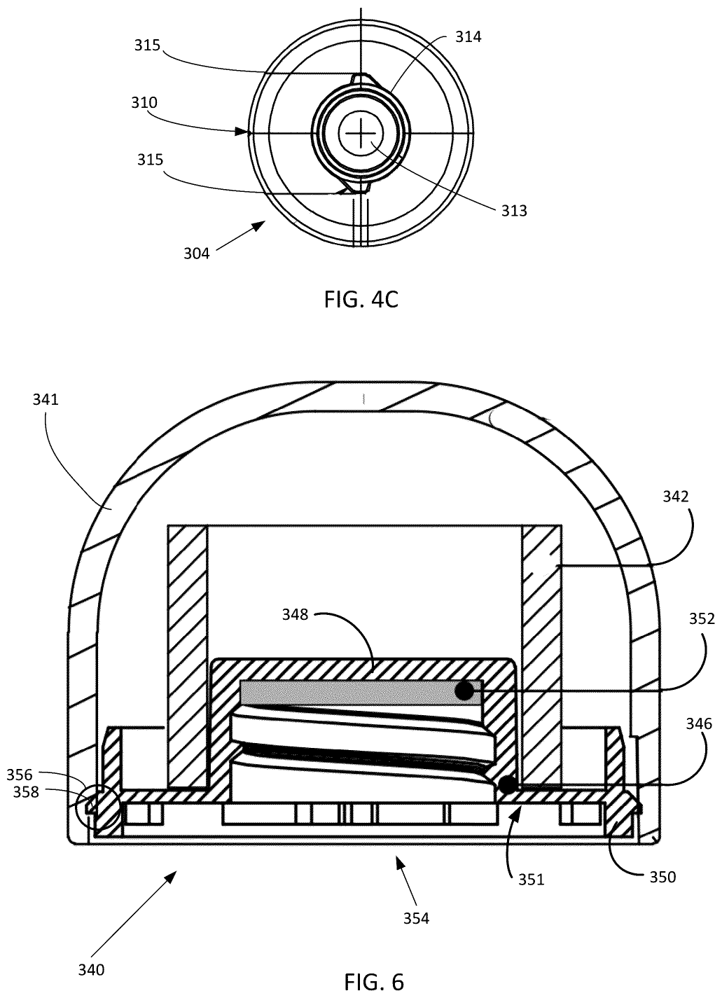

FIGS. 4A-4B respectively provide cross-section and front views of an exemplary replacement cartridge body for containing personal care liquid products for use with the replacement cartridge of FIG. 3A in accordance with a first embodiment of the present invention. As shown, capsule body 304 is generally cylindrical in shape and having a center axis 390. Capsule body 304 include as the top or upper portion a neck 314 that is threaded and defines or forms an opening or outlet 312. The neck serves two purposes—to connect the cap or cover 340 to the body and to connect the capsule to the support 160. A confirming tab or protuberance 315 may be included to provide feedback and confirmation that the cover is secured to the capsule body and/or that the capsule is properly secured to the support 160. Concentric rests 316 and 318 are provided to respectively provide abutment rests for engaging with the cap 340 and the inner portion of the support neck 163 and seal or washer 152 when attached to the support. An annular rest or end or abutment 320 is formed or defined on the neck and abuts with the pump engine adapter alone the extended annular lip or seat 369 (FIG. 5B) about the neck opening 312.

FIG. 4C provides a top-down view of the exemplary replacement cartridge body 304 and shows the neck 314, indicia 310, tabs 315 and having a seal or sifter 313 over the neck opening 312.

FIG. 5A provides a cross-section view of an exemplary pump engine adapter 360/tube 380 assembly for use with the replacement cartridge 300 of FIG. 3A. FIG. 5B provides an enlarged cross-section view of the exemplary pump engine adapter 360. As shown the pump engine adapter 360 includes an upper portion 362, which has an annular flange or lip 369, an intermediate or middle portion 364, and a lower or bottom portion 366. The tube 380 includes a lower opening or inlet 382 and an upper opening or outlet 384 at opposite ends of an elongated hollow body. Outlet 384 feeds into the pump engine adapter 360 at lower portion 366. An upper length or portion of the tube 380 is received in the lower portion 366 of the adapter 360 and is held snugly in place by friction fit or other suitable means capable of maintaining the positioning of the tube coupled with the adapter. The upper portion 362 of the adapter forms or defines a hollow interior or cavity 361 and an upper opening 367. The intermediate or middle portion 364 also forms or defines a cavity and the lower portion 366 is open at both ends to that a continuous and unimpeded path from the tube inlet 382, through the tube body, out the tube outlet 384, and into the adapter 360 at the lower opening 368 with the tube 380 connected to the adapter 360.

FIG. 6 provides an enlarged cross-section view of an exemplary cover or cap 340 for use with the replacement cartridge 300 of FIG. 3A and is shown having a dome-shaped over cap or cover 341, an inner member 342, which may serve as a weight to give added substance to the feel of the product, a lower receiving member 348 having a threaded neck portion 346, and a seal or insert 352 disposed within the threaded neck portion. The cap 340 is removably screwed onto the capsule body 304 by inserting the neck 314 of the capsule into the opening 354 formed in the lower receiving member 348 and engaging the cap threaded neck 346 with the cartridge threaded neck 314 until snug. With the cartridge inserted and secured to the cap, the upper lip 320 and upper flange or lip 349 abut against rest or stop 351. The cap is removed from the capsule by opposite action. The outer or over cap 341 may include an annular groove or recess or inset 356 to receive and engage with annular protuberance 358 formed in an outer circumference 350 of the lower receiving member 348.

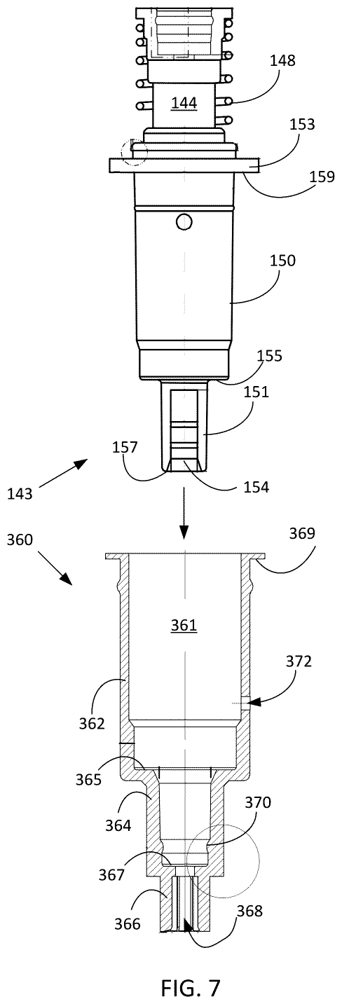

FIG. 7 provide a combination of a front view of a partial pump engine and tube interface assembly 143 of the dispenser 110 of FIG. 2A for joining with the pump engine adapter 360 of FIGS. 5A/5B of the cartridge 300. In this manner, the pump engine and tube interface assembly is inserted into the pump engine adapter 360 and occupies the hollow cavity 361 during an assembly process to arrive at a fully assembled dispenser assembly 100. As described above, the sub-assembly provides an uninterrupted path for liquid to flow from the reservoir 330, through the tube 380, through the pump engine assembly, and out the nozzle outlet of the spray head of the dispenser.

As best shown in FIG. 7, the pump engine and tube interface assembly 143 is inserted into the interior cavity 361 for mating the pump engine and tube interface assembly with the pump engine adapter 360 in the process of assembling the dispenser 110 and cartridge 300 to form a completed dispenser assembly 100. Pump cavities are formed in the pump engine and tube interface assembly 143 and an opening 154 is provided and defined in the lower end 151 of the tube interface to provide a continuous flow path through the pump assembly for the liquid product contained in the cartridge reservoir 330 for dispensing same via spray head nozzle outlet 142. Pump engine and tube interface assembly 143 includes a terminus or resting or abutting shoulder 157 at the lower extreme of lower end or tube connector 151 and an intermediate shoulder or abutment 155 at the lower extreme of capsule insertion portion or component 150. The pump engine adapter 360 includes an upper resting or supporting collar 365 and a lower resting or supporting collar 367. With the pump engine and tube interface assembly 143 inserted into the pump engine adapter 360, terminus or resting or abutting shoulder 157 abuts and rests upon the lower resting or supporting collar 367 and the intermediate shoulder or abutment 155 abuts and rests upon the upper resting or supporting collar 365 (as shown in FIG. 1A). As shown, the upper portion 362 of pump engine adapter 360 includes an opening or relief or exhaust or vent aperture or feature 372 to permit vacuum relief or other relief when the pump engine and tube interface assembly 143 inserted into the pump engine adapter 360. Also, collar 153 includes a lower surface 159 that rests upon bushing or washer or seal member 152, which in turn rests upon outer flange or collar 369.

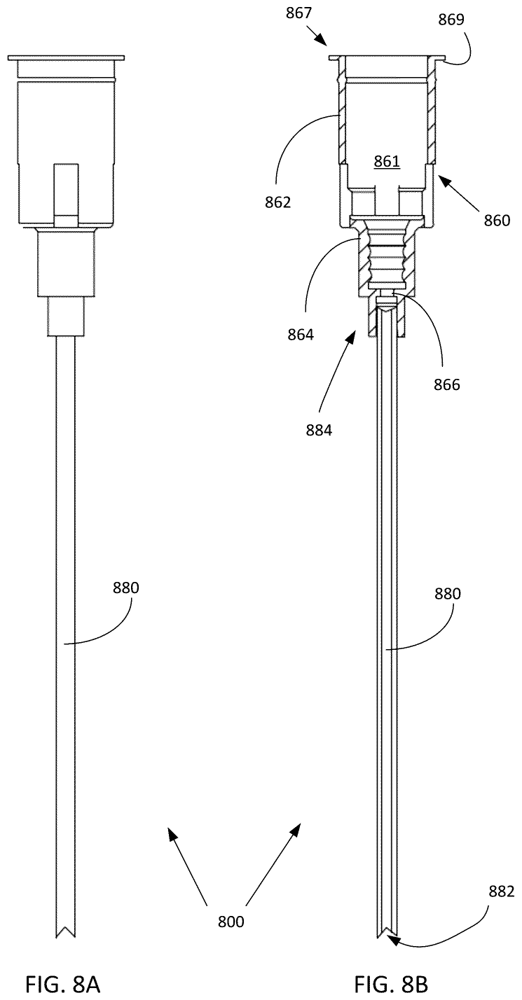

FIG. 8A provides a front view of an exemplary pump engine adapter 360/tube 380 assembly for use with the replacement cartridge 300 of FIG. 3A. FIG. 8B provides a cross-section view of the second exemplary pump engine adapter and tube assembly for use with the replacement cartridge of FIG. 3A in accordance with a second embodiment of the present invention. Specifically, FIG. 8B provides an enlarged cross-section view of the exemplary pump engine adapter 360 with attached tube assembly 880. As shown the pump engine adapter 860 includes an upper portion 862, which has an annular flange or lip 869, an intermediate or middle portion 864, and a lower or bottom portion 866. The tube 880 includes a lower opening or inlet 882 and an upper opening or outlet 884 at opposite ends of an elongated hollow body. Outlet 884 feeds into the pump engine adapter 860 at lower portion 866. An upper length or portion of the tube 880 is received in the lower portion 866 of the adapter 860 and is held snugly in place by friction fit or other suitable means capable of maintaining the positioning of the tube coupled with the adapter. The upper portion 862 of the adapter forms or defines a hollow interior or cavity 861 and an upper opening 867. The intermediate or middle portion 864 also forms or defines a cavity and the lower portion 866 is open at both ends to that a continuous and unimpeded path from the tube inlet 882, through the tube body, out the tube outlet 884, and into the adapter 860 at the lower opening 868 with the tube 880 connected to the adapter 860.

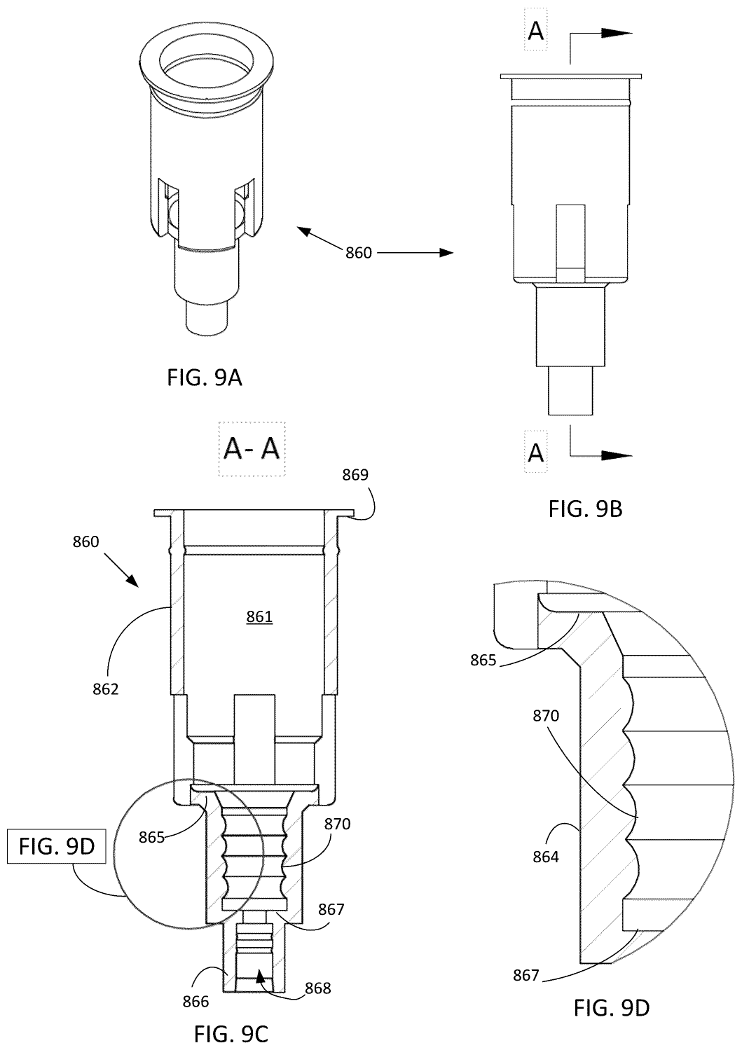

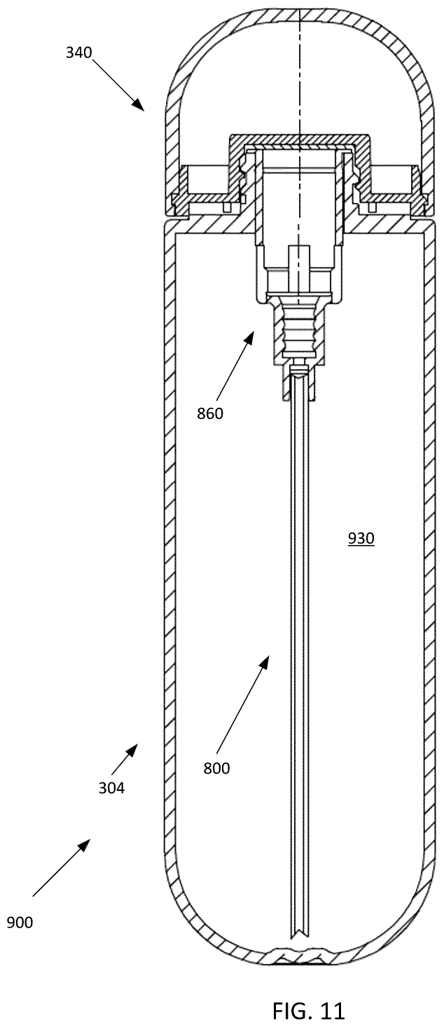

FIG. 9A provides a perspective view of the second exemplary pump engine adapter 860 for use with the replacement cartridge 900 of FIG. 11 in accordance with a second embodiment of the present invention. FIG. 9B provides a front view of the second exemplary pump engine adapter 860 for use with the replacement cartridge of FIG. 11 in accordance with a second embodiment of the present invention.

FIG. 9C provides a cross-section view of the second exemplary pump engine adapter 860 as taken along lines A-A of FIG. 9B for use with the replacement cartridge of FIG. 11 in accordance with a second embodiment of the present invention. The pump engine adapter 860 includes an upper resting or supporting collar 865 and a lower resting or supporting collar 867 and an upper flange 869. The upper portion 862 of pump engine adapter 860 is open at both the top and bottom and defines a cavity 861 and intermediate portion 864 defines an internal space having a set of inwardly projecting bumps or protuberances 870 and provides an abutment or stop 867 at a lower end and an abutment or stop 865 at an upper end. The lower portion of the adapter 860 provides a tube insertion and support extension 866 defining an opening 868 for receiving the upper end of a tube 880.

FIG. 9D provides a cross-section close-up view of an intermediate portion 864 of the second exemplary pump engine adapter 860 as taken from FIG. 9C for use with the replacement cartridge 900 of FIG. 11 in accordance with a second embodiment of the present invention.

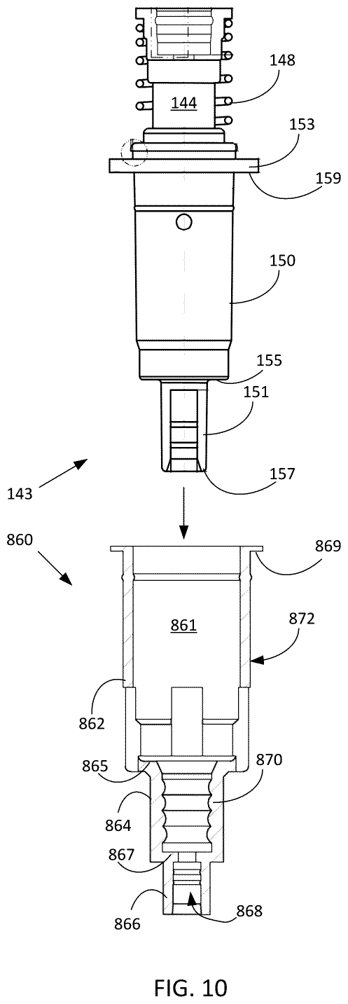

FIG. 10 provides a combination of a front view of a partial pump engine and tube interface assembly 143 of the dispenser 110 of FIG. 2A for joining with the second embodiment pump engine adapter 860 of FIGS. 8A-9D of the cartridge 300 (or cartridge 900 of FIG. 11). In this manner, the pump engine and tube interface assembly 143 (described above) is inserted into the alternative pump engine adapter 860 and occupies the hollow cavity 861 during an assembly process to arrive at a fully assembled dispenser assembly 100. As described above, the sub-assembly provides an uninterrupted path for liquid to flow from the reservoir 330 (or reservoir 930 of FIG. 11), through the tube 880, through the pump engine assembly 143/860, and out the nozzle outlet 142 of the spray head 140 of the dispenser 110.

As best shown in FIG. 10, the pump engine and tube interface assembly 143 is inserted into the interior cavity 861 for mating the pump engine and tube interface assembly with the pump engine adapter 860 in the process of assembling the dispenser 110 and cartridge 300 (or cartridge 900 of FIG. 11) to form a completed dispenser assembly 100. Pump cavities are formed in the pump engine and tube interface assembly 143 and an opening 154 is provided and defined in the lower end 151 of the tube interface to provide a continuous flow path through the pump assembly for the liquid product contained in the cartridge reservoir 330 (or reservoir 930 of FIG. 11) for dispensing same via spray head nozzle outlet 142. Pump engine and tube interface assembly 143 includes a terminus or resting or abutting shoulder 157 at the lower extreme of lower end or tube connector 151 and an intermediate shoulder or abutment 155 at the lower extreme of capsule insertion portion or component 150.

The pump engine adapter 860 includes an upper resting or supporting collar 865 and a lower resting or supporting collar 867 and an upper flange 869. With the pump engine and tube interface assembly 143 inserted into the pump engine adapter 860, terminus or resting or abutting shoulder 157 abuts and rests upon the lower resting or supporting collar 867 and the intermediate shoulder or abutment 155 abuts and rests upon the upper resting or supporting collar 865. As shown, the upper portion 862 of pump engine adapter 860 includes an opening or relief or exhaust or vent aperture or feature 872 to permit vacuum relief or other relief when the pump engine and tube interface assembly 143 inserted into the pump engine adapter 860. Also, collar 153 includes a lower surface 159 that rests upon bushing or washer or seal member 152, which in turn rests upon outer flange or collar 869. The series or plurality or set of internal narrowings or seals or steps 870 may serve as a sifter or wiper or cleaner as tube connector 151 is inserted lower portion 864 and may serve as a seal to prevent leakage of liquid product.

FIG. 11 provides a cross-section view of a second exemplary replacement cartridge 900 containing personal care liquid products and for use with the reusable liquid dispenser of FIG. 2A-2C in accordance with a second embodiment of the present invention. The cover or cap 340 is essentially as described above in connection with FIG. 6 for use with the replacement cartridge 300 of FIG. 3A.

Although the invention has been described in terms of an exemplary embodiment, the exemplary embodiment is intended only to assist in understanding the workings of the invention and is not limiting as to the inventive features and qualities as only limited by the claims that follow. The invention provides a liquid dispenser adapted to removably receive a replaceable capsule and dispense a liquid personal care product contained in an installed capsule. The dispenser includes a housing having a top and a bottom and defining an interior space. The housing top includes an opening. The dispenser includes a liquid spray pump assembly having a pump engine having an inlet and an outlet. The pump engine includes a tube interface component. The dispenser includes a removable cartridge adapted to be received within the interior space of the housing through the top opening. The cartridge defines a reservoir for containing liquid product, such as personal care liquid products, e.g., hair product. The cartridge includes a pump engine adapter configured to receive the pump engine tube interface component with the cartridge joined with the liquid spray pump assembly. A tube is disposed within the reservoir and has an elongated body with a first end supported by the pump engine adapter and defining an outlet, and a second end defining an inlet in communication with liquid product contained in the reservoir. The liquid spray pump assembly is configured to alternately attach to and detach from the housing to allow, alternately, for insertion and removal of a cartridge to facilitate replacement of a spent cartridge with a fresh replacement cartridge. With the cartridge joined with the liquid spray pump assembly, the pump engine adapter receives the pump engine tube interface and provides a continuous path for liquid from the reservoir to pass into and through the spray tube and into the liquid spray pump assembly. Upon actuation of the pump engine, liquid product contained in the reservoir is drawn into the tube via the tube inlet, flows through the tube and through the pump engine tube interface, and exits the pump engine outlet for dispensing of the liquid product for use by a user.

The liquid dispenser may include additional features and may be further characterized in one or more of a number of configurations. For example, the pump engine may be spring-biased and may be actuated upon a user depressing a spray head provided on the liquid spray pump assembly to cause the pump engine to draw a pre-determined amount of liquid from the reservoir. The housing may further comprise a support component adapted to removably attach to the top of the housing, the support component having a pump engine support portion adapted to join with and support the liquid spray pump assembly. The housing may include a threaded circumference at the housing top, and the support component may include a first set of threads adapted to mate with and removably secure the support component with the threaded circumference. The support component may include a cartridge support portion adapted to mate with and support the cartridge. The cartridge may include a threaded neck, and the support component includes a second set of threads adapted to mate with and removably secure the support component with the cartridge threaded neck. The dispenser may further comprise a cap adapted to be removably attached to the housing and adapted to cover and protect an exposed portion of the liquid spray pump assembly, including the outlet, and adapted to prevent undesired actuation of the pump engine. One or both of the pump engine tube interface and the pump engine may include a sifter adapted to clear or wipe liquid when the cartridge is removed from the body to prevent spillage and mess. The dispenser may further comprise a bottom cover for attaching to and protecting the bottom of the housing, the bottom cover having a flat portion to promote stability of the dispenser when placed on a flat surface. At least a portion of the housing may be transparent or semi-transparent to reveal at least in part the interior space, including a portion of the cartridge and the cartridge may include indicia disposed on the outside of the cartridge concerning the personal care product contained in the cartridge, whereby with the cartridge contained in the housing, the indicia is visible through the transparent or semi-transparent portion of the housing to ensure user awareness of personal care liquid dispensed.

Moreover, the invention further lies in the aspect of providing a replacement cartridge inventively configured for use with a complimentary dispenser as a replacement product. In this manner the invention further provides a cartridge containing personal care liquid and adapted for use with a dispenser for dispensing personal care liquid. The complimentary dispenser includes a pump engine and a housing adapted to removably receive a cartridge. The cartridge includes a body having a top and a bottom and generally defining a reservoir and is configured to be received within a correspondingly configured dispenser housing. The cartridge top defining an opening. The cartridge includes a pump engine adapter adapted to be received at least in part through the opening and into the reservoir and to be securely affixed to the top of the body. The pump engine being configured to receive a portion of a dispenser pump engine with the cartridge disposed in a dispenser. The cartridge includes a tube disposed within the reservoir, the tube having a first end supported by the pump engine adapter and having an outlet, and a second end having an inlet in communication with the liquid product contained in the reservoir. The tube and the pump engine adapter provide a continuous path through which liquid from the reservoir passes into and through the tube and into the pump engine adapter.

The cartridge may include further features and may be further characterized in one or more of the following manners. For example, the pump engine may be adapted to include a sifter to prevent liquid from flowing into the pump engine adapter from the reservoir. With a pump engine disposed into the pump engine adapter, the sifter is displaced to permit flow of liquid from the reservoir into the pump engine. Upon actuation of the pump engine, liquid product contained in the reservoir is drawn into the tube via the tube inlet, flows through the tube and through the pump engine adapter and into the pump engine, and exits a pump engine outlet for dispensing the liquid product. The cartridge body may further comprise a connector portion disposed at the top and adapted to matingly secure the cartridge to the dispenser housing with the cartridge received within the dispenser housing. The cartridge may include a cover removably affixed to the body and disposed over the opening and adapted to prevent spillage of the personal care product contained in the reservoir prior to installation of the cartridge in a dispenser housing. The cartridge may include a threaded neck and the dispenser housing includes a retaining cover oppositely threaded to receive the threaded neck, whereby the cartridge is adapted to be secured to the dispenser housing by threading and screwing the threaded neck to the retaining cover. The cartridge may further comprise a sifter disposed at or near the cartridge opening for clearing liquid upon disjoining the cartridge from the pump engine to prevent spillage and mess. The liquid product contained in the cartridge may be essentially maintained at atmospheric pressure and the dispenser act as an atmospheric spray pump.

While the invention has been described by reference to certain preferred embodiments, it should be understood that numerous changes could be made within the spirit and scope of the inventive concept described. Also, the present invention is not to be limited in scope by the specific embodiments described herein. It is fully contemplated that other various embodiments of and modifications to the present invention, in addition to those described herein, will become apparent to those of ordinary skill in the art from the foregoing description and accompanying drawings. Thus, such other embodiments and modifications are intended to fall within the scope of the following appended claims. Further, although the present invention has been described herein in the context of particular embodiments and implementations and applications and in particular environments, those of ordinary skill in the art will appreciate that its usefulness is not limited thereto and that the present invention can be beneficially applied in any number of ways and environments for any number of purposes. Accordingly, the claims set forth below should be construed in view of the full breadth and spirit of the present invention as disclosed herein.

What is claimed is:

1. A liquid dispenser adapted to removably receive a replaceable capsule and dispense a liquid personal care product contained in an installed capsule, the dispenser comprising:
a housing having a top and a bottom and defining an interior space, the top having an opening; and
a liquid spray pump assembly comprising a pump engine having an inlet and an outlet, the pump engine having a tube interface component;
a cartridge adapted to be received within the interior space of the housing through the top opening, the cartridge defining a reservoir for containing liquid product, the cartridge comprising:
a pump engine adapter configured to receive the pump engine tube interface component with the cartridge joined with the liquid spray pump assembly; and
a tube disposed within the reservoir, the tube having a first end supported by the pump engine adapter and defining an outlet, and a second end defining an inlet in communication with liquid product contained in the reservoir;
the liquid spray pump assembly being configured to alternately attach to and detach from the housing to allow, alternately, for insertion and removal of the cartridge to facilitate replacement of a spent cartridge with a fresh replacement cartridge;
whereby with the cartridge joined with the liquid spray pump assembly, the pump engine adapter receives the pump engine tube interface and provides a continuous path for liquid from the reservoir to pass into and through the spray tube and into the liquid spray pump assembly and, upon actuation of the pump engine, liquid product contained in the reservoir is drawn into the tube via the tube inlet, flows through the tube and through the pump engine tube interface, and exits the pump engine outlet for dispensing of the liquid product for use by a user.

2. The liquid dispenser of claim 1, wherein the pump engine is spring-biased and is actuated upon a user depressing a spray head provided on the liquid spray pump assembly to cause the pump engine to draw a pre-determined amount of liquid from the reservoir.

3. The liquid dispenser of claim 1, wherein the housing further comprises a support component adapted to removably attach to the top of the housing, the support component having a pump engine support portion adapted to join with and support the liquid spray pump assembly.

4. The liquid dispenser of claim 3, wherein the housing includes a threaded circumference at the housing top, and the support component includes a first set of threads adapted to mate with and removably secure the support component with the threaded circumference.

5. The liquid dispenser of claim 3, wherein the support component includes a cartridge support portion adapted to mate with and support the cartridge.

6. The liquid dispenser of claim 5, wherein the cartridge includes a threaded neck, and the support component includes a second set of threads adapted to mate with and removably secure the support component with the cartridge threaded neck.

7. The liquid dispenser of claim 1 further comprising a cap adapted to be removably attached to the housing and adapted to cover and protect an exposed portion of the liquid spray pump assembly, including the outlet, and adapted to prevent undesired actuation of the pump engine.

8. The liquid dispenser of claim 1, wherein one or both of the pump engine tube interface and the pump engine include a sifter adapted to clear or wipe liquid when the cartridge is removed from the body to prevent spillage and mess.

9. The liquid dispenser of claim 1, further comprising a bottom cover for attaching to and protecting the bottom of the housing, the bottom cover having a flat portion to promote stability of the dispenser when placed on a flat surface.

10. The liquid dispenser of claim 1, wherein at least a portion of the housing is transparent or semi-transparent to reveal at least in part the interior space, including a portion of the cartridge.

11. The liquid dispenser of claim 10, wherein the cartridge includes indicia disposed on the outside of the cartridge concerning the personal care product contained in the cartridge, whereby with the cartridge contained in the housing, the indicia is visible through the transparent or semi-transparent portion of the housing to ensure user awareness of personal care liquid dispensed.

12. A cartridge containing personal care liquid and adapted for use with a dispenser for dispensing personal care liquid, the dispenser having a pump engine and a housing adapted to removably receive a cartridge, the cartridge comprising:
a body having a top and a bottom and generally defining a reservoir and configured to be received within a correspondingly configured dispenser housing, the top defining an opening;
a pump engine adapter adapted to be received at least in part through the opening and into the reservoir and to be securely affixed to the top of the body, the pump engine being configured to receive a portion of a dispenser pump engine with the cartridge disposed in a dispenser; and
a tube disposed within the reservoir, the tube having a first end supported by the pump engine adapter and having an outlet, and a second end having an inlet in communication with the liquid product contained in the reservoir;
wherein the tube and the pump engine adapter provide a continuous path through which liquid from the reservoir passes into and through the tube and into the pump engine adapter.

13. The cartridge of claim 12, wherein the pump engine adapted includes a sifter to prevent liquid from flowing into the pump engine adapter from the reservoir.

14. The cartridge of claim 13, wherein with a pump engine disposed into the pump engine adapter, the sifter is displaced to permit flow of liquid from the reservoir into the pump engine.

15. The cartridge of claim 14, wherein upon actuation of the pump engine, liquid product contained in the reservoir is drawn into the tube via the tube inlet, flows through the tube and through the pump engine adapter and into the pump engine, and exits a pump engine outlet for dispensing the liquid product.

16. The cartridge of claim 12, wherein the cartridge body further comprises:
a connector portion disposed at the top and adapted to matingly secure the cartridge to the dispenser housing with the cartridge received within the dispenser housing.

17. The cartridge of claim 12, further comprising:
a cover removably affixed to the body and disposed over the opening and adapted to prevent spillage of the personal care product contained in the reservoir prior to installation of the cartridge in a dispenser housing.

18. The cartridge of claim 12, wherein the cartridge includes a threaded neck and the dispenser housing includes a retaining cover oppositely threaded to receive the threaded neck, whereby the cartridge is adapted to be secured to the dispenser housing by threading and screwing the threaded neck to the retaining cover.

19. The capsule of claim 12 further comprising a sifter disposed at or near the cartridge opening for clearing liquid upon disjoining the cartridge from the pump engine to prevent spillage and mess.

20. The capsule of claim 12 wherein the liquid product contained in the cartridge is essentially maintained at atmospheric pressure.
